(19) United States
(12) Patent Application Publication
(10) Pub. No.: US 2022/0114609 A1
(43) Pub. Date: Apr. 14, 2022

(54) TRANSPORTATION METHOD AND APPARATUS

(71) Applicant: GRABTAXI HOLDINGS PTE. LTD., Singapore (SG)

(72) Inventors: Aayush GARG, Singapore (SG); Chun Kai PHANG, Singapore (SG); Chandan Kumar ARGARWAL, Singapore (SG)

(21) Appl. No.: 17/423,534

(22) PCT Filed: Jan. 28, 2019
(86) PCT No.: PCT/SG2019/050042

§ 371 Date: Jul. 16, 2021

(51) Int. Cl. G06Q 30/02; G06Q 10/02; G06Q 50/30

(52) U.S. Cl. CPC G06Q 30/0206; G06Q 50/30; G06Q 10/02

(57) ABSTRACT

A transportation system is made up by a plurality of contiguous geographical cells. The effective availability of service for transportation service users is calculated on the basis of the number of eligible transportation service providers located in one or more of the geographical cells. The calculations may take into account a distance between each service provider and the users.

The invention is in the general field of data processing. Some embodiments relate to gathering, analysis and display of data representative of service provision in a transportation system. Some embodiments relate to ride-hailing type systems.

### BACKGROUND

Ride-hailing business in its simplest form is about matchmaking users looking for a mode of transport with service providers who can provide such transport. Data related to actual and predicted service provision and service demand can be the subject of machine-learning algorithms, and an aim of some systems is to fine-tune machine learning algorithms with the goal of ensuring that users get transportation when they want it, and that they are matched to service providers that are closest to them. However, service providers in general tend to be constantly on the move, and at any one instant there could be hundreds of users requesting transport within a relatively small area. This means that, sometimes, the closest available service providers might be too far away to allow rapid provision of desired transportation.

A desideratum is to be analyse these instances at scale via clearly-defined metrics.

An aim of some embodiments is to determine the supply and demand relationship at any given area and time.

### SUMMARY

In one aspect there is provided a method of operating a transportation system, the system comprising a plurality of contiguous geographical cells, the method comprising calculating the effective availability of service for at least one user on the basis of eligible service providers located in one of more of said cells.

In one arrangement, the method comprises taking into account the distance from each of plural service providers to a user.

In one arrangement, the method further comprises determining a demand parameter for each of the plurality of contiguous geographical cells.

In another aspect there is disclosed apparatus for operating a transportation system, the apparatus being configured for calculating the effective supply per user on the basis of a number of eligible service providers located in one of more said cells, including a cell in which the said user is located.

In an embodiment, the apparatus is configured to receive data indicative of location of eligible service providers from service provider devices. In an embodiment, the data indicative of service provider location is received using push technology. In an embodiment, the data indicative of service provider location is received asynchronously and is streamed into a provider message queue for synchronous processing.

In an embodiment, the apparatus is configured to receive data indicative of the user location. In an embodiment the data indicative of user location is received asynchronously and is streamed into a user message queue for synchronous processing.

In an embodiment, the apparatus comprises server devices configured to receive provider data synchronously from the provider message queue and user data synchronously from the user message queue, to aggregate the synchronous provider data into an aggregated provider data stream, and to aggregate the synchronous user data into an aggregated user data stream.

In an embodiment, the apparatus comprises a spatial database configured to be addressed using data from the aggregated provider stream.

In an embodiment, the apparatus comprises a processor device configured to execute instructions stored in memory to effect the following algorithm.
1. Collect group of parameters (user; provider; distance; cell location)
2. GroupByProvider=>Provider((user1, distance1, cell),(user2, distance2, cell2)
3. Calculate for each provider, ratio (weighted by summing distance1, distance 2 from above), provider contributes to each user and emit (user1, geohash1, ratio1)
4. GroupByCell=>Cell 1 ((user1, ratio1), (user2, ratio2))
5. Sum all users for each cell to get total demand
6. Sum all ratios for each cell to get total supply
7. Divide total demand/total supply=>S/D metric for each cell
8. Write output data.

In a further aspect there is provided a method of operating a geographically distributed transport system having plural mobile resources and plural consumers, the method comprising receiving consumer location data from at least one consumer and resource location data from at least one resource, using the resource location data as an index to a spatial database to determine data indicative of points around the location of the resource, and processing the consumer location data along with the data indicative of points around the resources to group around each resource to determine the effective supply of resources per consumer.

In an embodiment the mobile resources are service providers, for example drivers. In an embodiment the consumers are service users, for example passengers.

In a further aspect there is disclosed, in a transportation system operating system, having plural users, each forming a unit of demand, plural service providers, each forming a unit of supply, the transportation system comprising a plurality of geographical cells defining together an operating region, a method for determining the effective supply per user comprising the steps of:—determining units of demand located in each cell for a time-slot;
determining units of supply located in each cell for said time-slot;
determining eligible supply units on the basis of at least one parameter;
identifying demand units around the location of each eligible supply unit
calculating straight line distance between each eligible supply unit-demand unit pair; and
getting effective supply by:—
a Computing straight line distance ratio for each eligible supply unit-demand unit pair
b. Calculating weighting of each pair
c. Inversing the calculated weighting for each pair
d. Computing the proportion of inverse calculated weighting as effective supply.

In an alternative, rather than calculating straight line distance a route or road distance may be calculated. This may be in a different iteration.

A traditional method of attempting to determine supply and demand is a simple ratio of number of drivers and riders. This may lead to many inaccuracies (such as a service requester on the border of a defined area may be close to a service provider on the other side of the defined border).

Embodiments can be arranged to get a more accurate picture of supply and demand in space and time.

### BRIEF DESCRIPTION OF THE DRAWINGS

In the accompanying drawings:

FIG. 1 is a schematic block diagram illustrating a first exemplary communications server apparatus for operating a transportation system

FIG. 2 shows a simplified diagram of a part of a ride-hailing system, in this case illustrating nine cells with one service provider device and three users requesting a service;

FIG. 3 shows a chart illustrating a simple calculation for the part system of FIG. 2;

FIG. 4 is a map of Singapore with an example of supply-demand gap on a typical day;

FIG. 5 is a map similar to that of FIG. 4, but showing supply-demand distribution;

FIG. 6 is a graph of Typical Supply Demand Distribution in a small residential area in Singapore across the day;

FIG. 7 shows an exemplary graphical display from a demand Widget on a user device showing best times to book in River Valley (Singapore);

FIG. 8 is a partial block diagram illustrating some aspects of an architecture of a system for part of the ride hailing system; and.

FIG. 9 shows a partial flowchart carried out by a processor of the system of FIG. 8.

### DETAILED DESCRIPTION

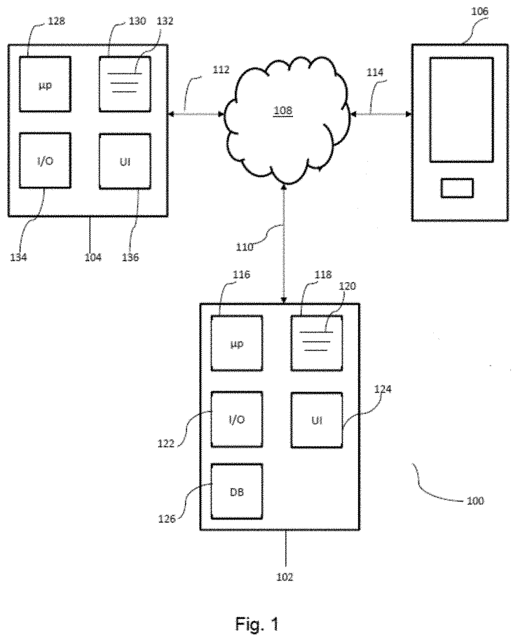

Referring first to FIG. 1, a communications system 100 is illustrated. Communications system 100 comprises communications server apparatus 102, service provider communications device 104 and user communications device 106. These devices are connected in the communications network 108 (for example the Internet) through respective communications links 110, 112, 114 implementing, for example, internet communications protocols. Communications devices 104, 106 may be able to communicate through other communications networks, such as public switched telephone networks (PSTN networks), including mobile cellular communications networks, but these are omitted from FIG. 1 for the sake of clarity.

Communications server apparatus 102 may be a single server as illustrated schematically in FIG. 1, or have the functionality performed by the server apparatus 102 distributed across multiple server components.

In the example of FIG. 1, communications server apparatus 102 may comprise a number of individual components including, but not limited to, one or more microprocessors 116, a memory 118 (e.g. a volatile memory such as a RAM) for the loading of executable instructions 120, the executable instructions defining the functionality the server apparatus 102 carries out under control of the processor 116. Communications server apparatus 102 also comprises an input/output module 122 allowing the server to communicate over the communications network 108. User interface 124 is provided for user control and may comprise, for example, conventional computing peripheral devices such as display monitors, computer keyboards and the like. Server apparatus 102 also comprises a database 126, the purpose of which will become readily apparent from the following discussion.

Service provider communications device 104 (hereinafter “service provider device”) may comprise a number of individual components including, but not limited to, one or more microprocessors 128, a memory 130 (e.g. a volatile memory such as a RAM) for the loading of executable instructions 132, the executable instructions defining the functionality the service provider device 104 carries out under control of the processor 128. Service provider device 104 also comprises an input/output module 134 allowing the Service provider device 104 to communicate over the communications network 108. User interface 136 is provided for user control. If the service provider device 104 is, say, a smart phone or tablet device, the user interface 136 will have a touch panel display as is prevalent in many smart phone and other handheld devices. Alternatively, if the service provider device is, say, a conventional desktop or laptop computer, the user interface may have, for example, conventional computing peripheral devices such as display monitors, computer keyboards and the like.

User communications device 106 (hereinafter “user device”) may be, for example, a smart phone or tablet device with the same or a similar hardware architecture to that of service provider device 104.

In an embodiment, for providing a ride-hailing service a user employs a user device 106 to request a ride. It should be noted that the term “ride” is used for simplicity—the term is not intended to be restrictive and is intended to cover a plurality of different scenarios—for example where a user requests a service provider to pick up some item and deliver it to a specific address. In this embodiment, the user device 106 runs an application that provides a graphical under interface on the device, allowing a user to request a ride, for example by specifying a destination. In some cases, input of the starting location is required, and provision may be made for input of a time for the ride, which may of course be “as soon as possible”.

This information is transmitted via the communications network 108 to the server apparatus 102, where its information is stored in the database 126. The server 102 in an embodiment runs a program that enables the ride request information to be forwarded to a particular service provider device 104. The server apparatus 102 is programmed to choose the specific service provider device 104 in this embodiment on the basis of information pushed to the server apparatus 102 from each service provider device 104, indicating the location of each service provider device and the state of availability of the service provider. Hence in this embodiment the server apparatus 102 is programmed to select the service provider device of a nearest eligible service provider (where “eligible” means idle or about to become idle).

The service provider has the option of accepting the job or not accepting it.

Assuming the specific service provider accepts the job of providing a service to the user, this information is provided from the provider device 104 to the server apparatus 102, which causes this information to be stored in database 126 and also sends confirmation of service only to the user device of the user who made the request. In an embodiment, the predicted delay before the provider can reach the user is also sent.

The server apparatus 102 is programmed to gather information on location of users and service providers and to store data indicative of that information. This data is, in the present embodiment, of a high level of detail and include details of each journey, each rider, each service provider.

The above description relates to a simplistic arrangement where service providers are usually readily available and where potential users are compliant and will accept a ride at some time in the future if an available service provider cannot be found quickly.

However, in the real-world, as noted above, service providers may be constantly on the move, and at any one point there could be hundreds of users requesting service within the same area. This means that, sometimes, the closest available service providers might be too far away to provide a satisfactory service.

Arrangements described herein process one or both of the information stored in the database 126 and real-time data from service provider devices to affect the information supplied to other processes run on or by the server apparatus 102. These other processes may, for example, advise idle service providers to where they can move to increase the likelihood of a job, or to improve the likelihood of high revenue job. The outcome of the describe arrangements may also or instead provide a display of the relationship between supply and demand.

In the following description, a single unit of supply is a service provider who is online and idle (not currently on a job) at the beginning of a determined time period, referred to hereinafter as a time-slot. A GPS ping at the beginning of each such time-slot from each service provider device is taken to be his or her location.

A non-limiting example time-slot duration is 120 seconds.

A single unit of demand is a user who is checking the price for service (e.g. transportation) within the same time-slot. The user's location in an embodiment is selected to be a pick-up address entered. In another embodiment it is the actual current location transmitted by the user device.

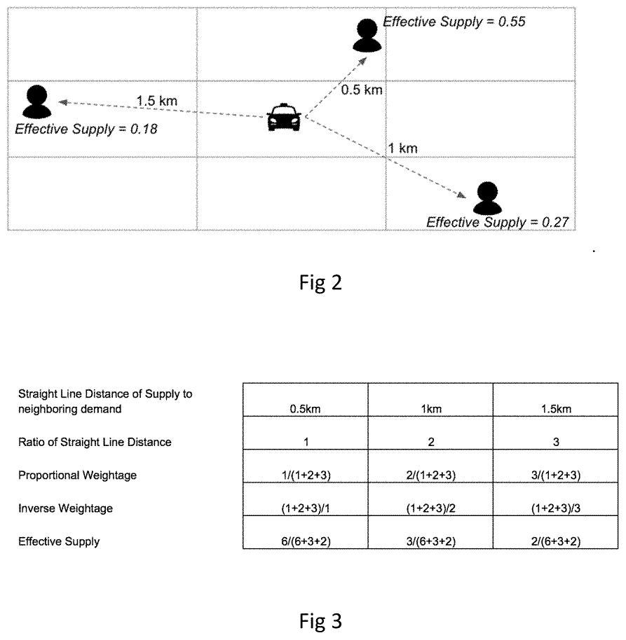

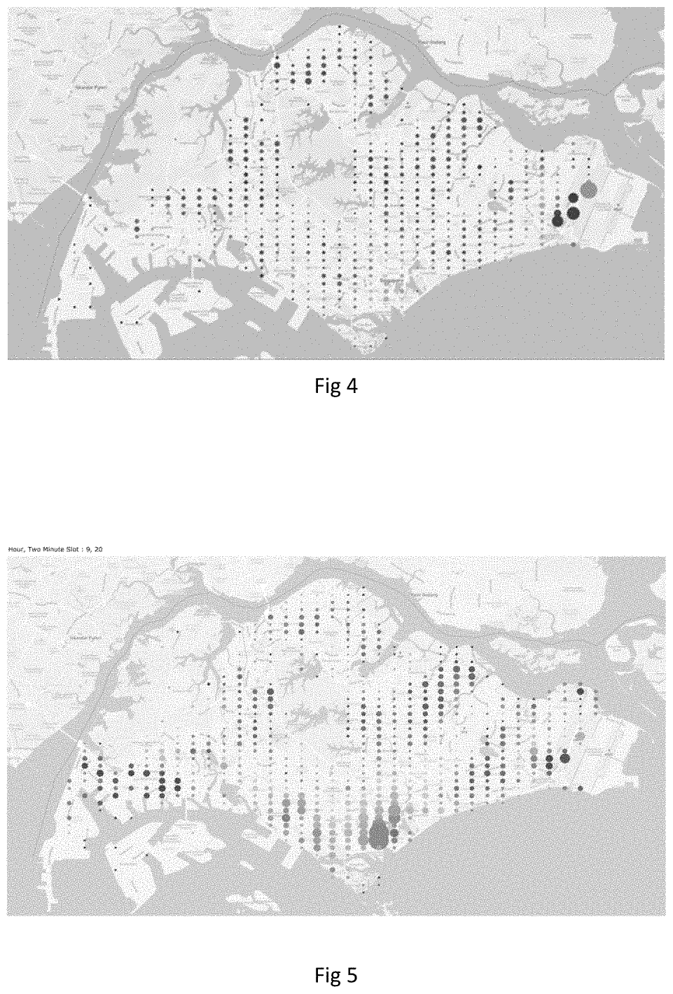

Referring to FIG. 2, in the following disclosure a geographical area—for example a city with its surrounding suburbs, is divided into cells. In some embodiments, these cells are defined by so-called “geohexes” (a hexagonal equivalent of a geohash). In others the cells are defined by geohashes. In one such embodiment, locations are aggregated to a geohash (a geographic location encoded into a string of letters and digits) with a precision of y where y refers to a very small polygon space of dimensions on the map. In a non-limiting example, a cell size is 1.2 km×609.4 m (Geohash 6)

It is envisaged that cells may be of varied shape and size.

Each supply unit is then mapped to all units of demand within the cell where the supply is located, and in this case, to the next outer cells as shown in FIG. 2.

A fraction of each supply unit is then assigned to each unit of demand in the neighbouring cells inversely weighted by distance, with the total of the fractions summing to unity. Essentially, this means that a service provider is more available to nearer users than more distant ones.

In this embodiment, straight line distance instead of route distance is used as a proxy to reduce the complexity of the algorithms. In another embodiment, route distance itself is used.

The method for determining the effective supply per user (i.e. per unit of demand) is as follows:

1. Determine units of demand located in each area-time-slot (with latitude & longitude)

2. Determine units of supply located in each area-time-slot (with latitude & longitude)

3. Identify demand units around the location of each eligible supply unit

4. Calculate straight line distance between each eligible supply unit-demand unit pair

5. Get effective supply by:—
a Computing straight line distance ratio for each eligible supply unit-demand unit pair
b. Calculating weighting of each pair
c. Inversing the calculated weighting for each pair
d. Compute proportion of inverse calculated weighting as effective supply

In one embodiment “eligible supply units” are determined with reference to a demand unit as being supply units in the same cell as the cell of the demand unit and supply units in cells contiguous with that cell. In another embodiment, the degree of closeness of cells is not constant with location, so in a peak hour business district (CBD) eligible supply units could be found in cells beyond the contiguous cells. In yet other embodiments the cells to determine eligibility vary with time.

Summation of fractions for each user for all providers available to the users in that cell gives the effective supply for each user. Summing all this for a particular user gives an indication of how well that user is serviced at that time-slot. FIG. 2 depicts how well each user is serviced by the illustrated car; each user shares a fraction of the supply.

Demand and effective supply are aggregated across a number of cell i and a time-slot j combination, resulting in two simple aggregated metrics: Supply Demand Ratio and Supply Demand Difference (FIG. 3).

In some embodiments, aggregation is not performed across all cells and all time-slots. The fractional distribution of service providers due to distance gives a granular picture of supply and demand in a small area and time. If aggregated to larger areas, the distribution due to position of the service providers in the middle of the area is lost.

In one family of embodiments, the data for all price checks and provider locations are stored in the database historically. Using multiple layers of SQL queries, the metrics mentioned are derived for historic data.

In another family of embodiments similar logic is replicated in production (engineering systems) where the input data (price checks and provider locations) flow in via real time message queues. Hence, if required, the metrics may be calculated in real time (or 2-5 min lag). This way the data can be used for features like heatmap, pricing, incentives in the app in real time.

In some embodiments, the calculations are performed for only the current situations, that is, the current time-slot. This allows oversight of the supply/demand situation.

In other embodiments, the calculations are performed for each time-slot as it arises, and the values of effective supply and demand are stored in the data base 126. Then at a suitable time, for example at the end of each clock-hour, the supply-demand ratio and supply/demand differences are summed to provide indications of performance.

So, in the equations below for this basic form, the sum of “Effective supply” is the sum of effective supply values for all users in that cell in that time-slot (i=1, j=1). This takes into account the “effective supply” for a user with respect to more than one car. So, for a scenario where there are three users in a particular cell and two cars able to service each of those three users, we calculate the effective supply score for a user 1 with car 1, user 2 with car 1 and user 3 with car 1, user 1 with car 2, user 2 with car 2 and user 3 with car 2. The effective supply score is the summation of all of the effective supply scores for users 1, 2 and 3 for each of cars 1 and 2.

Following equations 1a and 1b illustrate aggregation when aggregating across plural geographical cells for a current time-slot.

$$Equations 1 a and 1 b$$

$$Supply demand ratio = \frac{{\sum }_{i = 0}^{m} Effective {supply}_{i}}{{\sum }_{i = 0}^{m} {Demand}_{i}} \\ Supply demand difference = \vert {\sum }_{i = 0}^{m} Effective {supply}_{i} - {\sum }_{i = 0}^{m} {Demand}_{i} \vert ,$$

By contrast equations 2a and 2b illustrate the aggregation when aggregating across plural geographical cells and plural time-slots.

$$Equations 2 a and 2 b$$

$$Supply demand ratio = \frac{{\sum }_{i = 0}^{m} {\sum }_{j = 0}^{n} {EffectiveSupply}_{ij}}{{\sum }_{i = 0}^{m} {\sum }_{j = 0}^{n} {Demand}_{ij}}$$

$$Supply demand difference = \vert {\sum }_{i = 0}^{m} {\sum }_{j = 0}^{n} {EffectiveSupply}_{ij} - {\sum }_{i = 0}^{m} {\sum }_{j = 0}^{n} {Demand}_{ij} \vert$$

$$Equations 3 a and 3 b$$

$$Supply demand ratio = \frac{{\sum }_{j = 0}^{n} Effective {supply}_{i}}{{\sum }_{j = 0}^{n} {Demand}_{i}} \\ Supply demand difference = \vert {\sum }_{j = 0}^{n} Effective {supply}_{i} - {\sum }_{j = 0}^{n} {Demand}_{i} \vert ,$$

And equations 3a and 3b show the calculation for a single specified geographical cell aggregating across the timeslots j=0 to j=n.

If the supply/demand ratio is greater than 1, this indicates an oversupply. If the supply demand ratio is less than 1, this indicates an undersupply. The supply-demand difference indicates the extent (magnitude/scale) of the oversupply/undersupply. Also, whether there is oversupply or undersupply can be determined from the “supply demand difference” calculation (as long as we do also take into consideration whether the result is a positive number or a negative number. For instance, if the result yields a positive number, then this indicates an oversupply and if the result yields a negative number, then this indicates an undersupply.

Processing the Data

$$\frac{{\sum }_{i , j = 0}^{n , m} Effective {Supply}_{ij}}{{\sum }_{i = 0}^{n} Dema n {d}_{ij}}$$

While the resulting metrics may look like a simple ratio and difference, calculating effective supply, which requires mapping every driver and passenger in neighbouring space, is a considerably heavy computation.

Across the region, there could be hundreds of thousands of passengers looking for a ride at any given point in time. Embodiments of algorithms not only identify each demand and supply unit and its location, but also map every supply unit to all the demand units in the same neighbourhood to output the fractional supply available to each passenger.

Every extra unit of supply or demand substantially increases the algorithm's computation power requirements.

With the metrics discussed above, we can map out how gaps between demand and supply can evolve throughout the day. FIG. 3 displays Singapore's supply demand gap on a typical day, in this case for an average derived from 16 weekdays.

Each bubble indicates an area on the map. The size of each bubble indicates the supply-demand difference in that area—the bigger the bubble, the bigger the gap. The bubbles are coloured to indicate the supply/demand ratio where red signifies undersupplied and green signifies oversupplied.

To meet a goal of ensuring that users can always find a ride whenever they want it, there is a need to balance demand and supply. On one hand this is addressed by finding ways to move oversupply to areas where there is higher demand, and on the other by shifting less time-sensitive demand away from peak time-slots.

At any given time of the day, there may be an oversupply of drivers in one area while there is undersupply in others.

As shown in FIG. 5, this is common in Singapore after morning peak hours when most rides end in CBD which results in an oversupply in the area. Such scenarios are also common at queueing spots such as airports e.g. Changi Airport.

To address this geo-temporal misalignment, in an embodiment, a heatmap displayed on the service provider device encourages drivers to move away from oversupplied areas to areas where there is higher demand.

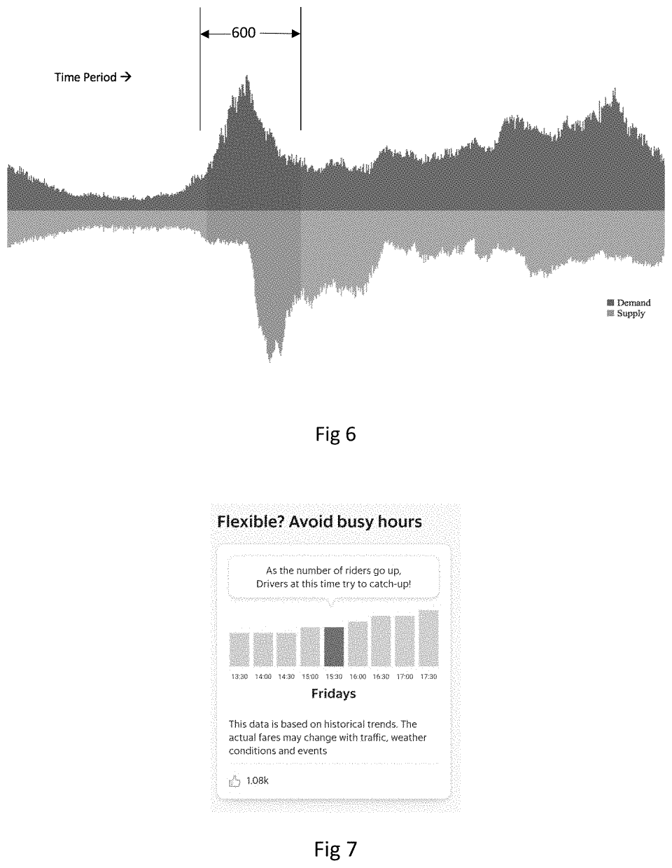

FIG. 6 is an aggregated representation of supply and demand on a typical weekday in a small residential area in Singapore.

The highlighted region 600 in FIG. 6 depicts a time period when demand (above the horizontal time axis) and supply (below the horizontal time axis) are mismatched.

Using historical data, it is known that demand can peak due to both expected factors, such as usual peak hours and less predictable factors, such as sudden heavy rain. However, supply grows at a later time, often when the demand is already subsiding.

To address this imbalance, in an embodiment, user devices can be operated to show likely demand distribution across hours. This is achieved using a so-called widget, where a widget is defined as element of a graphical user interface (GUI) that displays information, such as that of FIG. 7. The widget shows demand trends, based on the summation of historical data for a user's specific location. The goal here is to encourage time-insensitive demand (users who don't need a ride immediately) to delay their journey to book at a time when demand is less. This helps passengers with more urgent needs to get allocated with higher ease, and also allows the time-insensitive user to see high demand times when journey charges are higher.

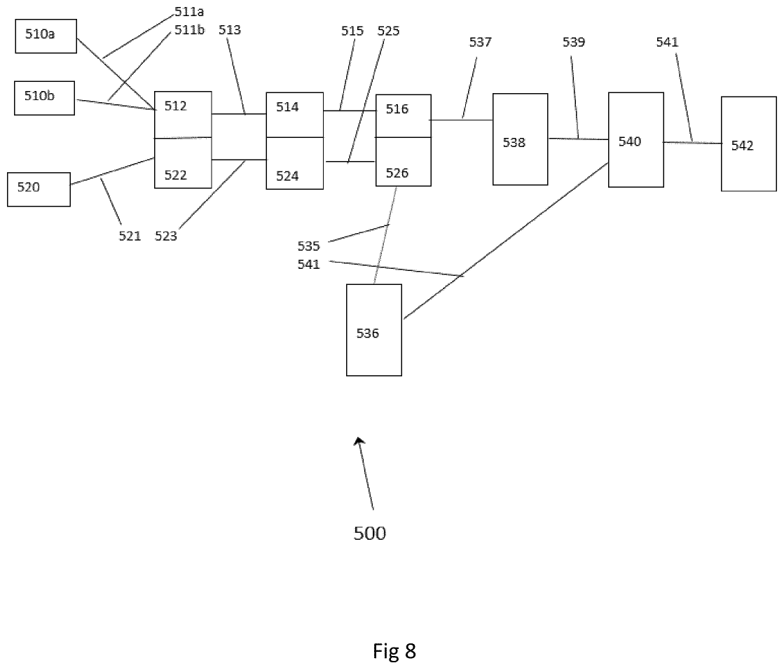

An example of a part of the platform is now described with reference to FIG. 8. This Figure shows an example architecture, which is not intended to be limiting.

The diagram of FIG. 8 shows two service providers, each having a respective service provider app 510a, 510b, and a single intending user with a user app 520. There will of course usually be many service providers and many potential users, but the number is small here for ease of understanding.

The service provider and user apps 510a, 510b and 520 are arranged to connect, for example via wireless links such as the Internet to an input server device consisting of first and second server devices 512,522.

The server devices 512,522 are configured to output signals via conductive links to message queues 514, 524, which in turn are connected via conductive links to first and second consumer server devices 516, 526.

The first consumer server device 516 is connected via a conductive link to a spatial database 538; the second consumer server 526 connects via a conductive link to real-time events message queue 536.

Both the real-time events message queue 536 and the spatial database 838 are connected conductively to the real-time events framework 540, and this in turn is connected to output data to a cache 542.

Although conductive links are mentioned above, these are not essential to the invention and other connections are envisaged.

Data arrives at the server devices 512, 522 in an asynchronous fashion from both service provider devices 510a,510b (e.g. the apps on drivers' devices) and from user apps 520 of intending users (e.g. passengers). To allow for synchronous processing, the two asynchronous data flows are formed into respective message queues.

In this embodiment, each service provider device 510a, 510b, as described elsewhere in this document, runs an app and this app periodically pushes a respective message 511a, 511b to first servers 512 of the processing device 500. In an example, the app pushes data every 10 seconds, although this time is purely an example and other periods are envisaged. The first server 512 streams data from the messages 511a, 511b as a packetised data stream 513, to store in a first message queue 514. In an embodiment, each unit of data at very high level looks like this->(providerID, location, state) where location=(latitude, longitude), and state can be any one of (online, available, on_job). Thus, the data transferred includes information indicative of location of the service provider device and data indicative of state of the respective service provider.

In other embodiments, as noted elsewhere, the system may poll the service provider devices for state and other data, rather than using push technology

When a potential user uses his user device 520 to access the hailing system for example to check a fare or check other information, this access is passed to second server 522. Server 522 periodically streams the content of messages 521 as a packetized data stream to a second message queue 524.

Each unit of data at very high level looks like (PassengerID, pickUplocation, time_when_fare_was_checked)

Data 515, 525 from the two message queues 521 and 523 pass to respective consumer servers 516, 526, which provide backend services. In an embodiment they are programmed in the language “Go”.

The consumer server 526 aggregate all potential users, e.g. those who are checking fares on a per-cell basis, for example on a per cell (or Geohash) basis using data 525 and streams the packetized aggregated data 535 into real-time events message queue 536. The aggregated data 535 in an embodiment includes accumulated fare checks per geohash for a specified time window, in an example a 2 minute window. In an embodiment each packet is:—Cell 1 [{UserID1,PickUpLocation}, {UserID2,PickUpLocation}].

The consumer servers 516, passes packetized data 537 to the spatial database 538, the data 537 being derived from data 515 and being representative of service providers who are online and idle. Thus, those service providers are indexed in the spatial database 538.

The spatial database 538 is optimized for storing and querying data that represents objects defined in a geometric space. It uses indexing to quickly look up values based upon the spatial index, and provides the ability to find and output all points within a specified radius of each input index value of the stream 537. The output stream 539 of the spatial database 538 is passed to a real time data processing framework 540, along with data 541 from the real-time events queue 536.

The real-time events framework 540 receives data 541 (list of passenger and their locations per geohash) and for each passenger per geohash finds all drivers within radius say 1 KM using data 539.

An example algorithm follows:
Collect parameters (passenger,driver,distance,geohash)
GroupByDriver=>Driver1((passenger1, distance1, geohash1),(passenger2, distance2, geohash2))* * this represents set of all passengers for which this driver(Driver 1) is source of supply
Calculate for each driver, ratio(weighted by summing distance1,distance 2 from above), it contributes to each passenger and emit (passenger1, geohash1, ratio1)
GroupByGeohash=>Geohash1((passenger1,ratio1), (passenger2,ratio2))
Sum all passenger for each geohash to get total demand
Sum all ratios for each geohash to get total supply
Divide total demand/total supply=>S/D metric for each geohash
Write the outputs to Cache

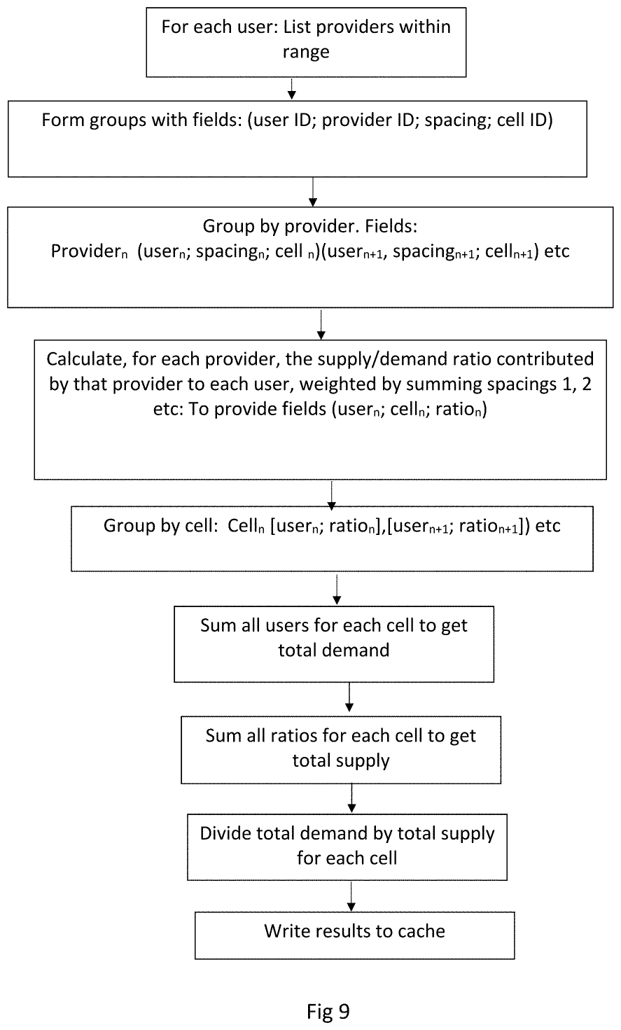

The algorithm is shown more fully in FIG. 9.

Data 539 from the real-time events framework is output to cache 540 for storage, to enable rapid writing (from 539) and reading to the various applications (not shown). Such applications include driver heatmap, surge pricing and demand prediction.

In another family of embodiments, the determination of effective supply is not performed directly a time-slot ends, but instead is performed at another time. In one of these other embodiments the calculations for the whole previous day are performed during night hours when demand is less.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A method of operating a transportation system, the system being made up by a plurality of contiguous geographical cells, the method comprising calculating the effective availability of service for at least one user on the basis of the number of eligible service providers located in one or more of said geographical cells.

2. A method according to claim 1 comprising taking into account the distance from each service provider to the or each said user.

3. A method according to claim 1, further comprises determining a demand parameter for each of the plurality of contiguous geographical cells.

4. Server apparatus for operating a transportation system comprising a processor and a memory, the communications server apparatus being configured, under control of the processor, to execute instructions stored in the memory: for calculating the effective supply per user on the basis of a number of eligible service providers located in one of more said cells, including a cell in which the said user is located.

5. A transportation system operating system, having plural users, each forming a unit of demand, plural service providers, each forming a unit of supply, the transportation system comprising a plurality of geographical cells defining together an operating region, and server apparatus having a processor and a memory, the server apparatus being configured, under control of the processor, to execute instructions stored in the memory to determine the effective supply per user by the steps of:—
determining units of demand located in each cell for a time-slot;
determining units of supply located in each cell for said time-slot;
determining eligible supply units on the basis of at least one parameter;
identifying demand units around the location of each eligible supply unit calculating straight line distance between each eligible supply unit-demand unit pair; and
getting effective supply by:—
a Computing straight line distance ratio for each eligible supply unit-demand unit pair
b. Calculating weighting of each pair
c. Inversing the calculated weighting for each pair; and
d. Computing the proportion of inverse calculated weighting as effective supply.

6. Apparatus for operating a transportation system, the apparatus being configured for calculating the effective supply per user on the basis of a number of eligible service providers located in one of more said cells, including a cell in which the said user is located.

7. The apparatus of claim 6, configured to receive data indicative of location of eligible service providers from service provider devices using push technology.

8. The apparatus of claim 6 configured such that data indicative of location received asynchronously can be streamed into a provider message queue for synchronous processing.

9. The apparatus of claim 6 configured to receive data indicative of the user location asynchronously to stream the user location data into a user message queue for synchronous processing.

10. The apparatus of claim 6, comprising server devices configured to receive synchronous provider data from the provider message queue and synchronous user the user message queue, to aggregate the synchronous provider data into an aggregated provider data stream, and to aggregate the synchronous user data into an aggregated user data stream.

11. The apparatus of claim 10 comprising a spatial database configured to be addressed using data from the aggregated provider stream.

12. The apparatus of claim 6, comprising a processor device configured to execute instructions stored in memory to effect the following algorithm.
1. Collect parameters (user,provider,distance,cell location)
2. GroupByProvider=>Provider((user1, distance1, cell),(user2, distance2, cell2)
3. Calculate for each provider, ratio (weighted by summing distance1,distance 2 from above), provider contributes to each user and emit (user1, geohash1, ratio1)
4. GroupBycell=>Cell 1 ((user1,ratio1), (user2,ratio2))
5. Sum all users for each cell to get total demand
6. Sum all ratios for each cell to get total supply
7. Divide total demand/total supply=>S/D metric for each cell
8. Write outputs
